(19) United States
(12) Patent Application Publication
(10) Pub. No.: US 2015/0044039 A1
(43) Pub. Date: Feb. 12, 2015

(54) EXHAUST DIFFUSER SHELL WITH FLANGE AND MANUFACTURING METHOD

(71) Applicants: Yevgeniy Shteyman, West Palm Beach, FL (US); Matthew R. Porter, West Palm Beach, FL (US); Mrinal Munshi, Orlando, FL (US); Douglas R. Roth, Oviedo, FL (US); Timothy J. Stewart, JR., Charlotte, NC (US)

(72) Inventors: Yevgeniy Shteyman, West Palm Beach, FL (US); Matthew R. Porter, West Palm Beach, FL (US); Mrinal Munshi, Orlando, FL (US); Douglas R. Roth, Oviedo, FL (US); Timothy J. Stewart, JR., Charlotte, NC (US)

(21) Appl. No.: 13/961,920

(22) Filed: Aug. 8, 2013

(51) Int. Cl. F01D 25/30

(52) U.S. Cl. CPC F01D 25/30; F05D 2230/232
USPC 415/207; 29/890.08

(57) ABSTRACT

Manufacture of an arcuate diffuser shell (38A/38B) assembled from an axially forward portion (38A) and an axially aft portion (38B), the two portions welded to respective sides of an arcuate flange (58A) via two respective pairs of circumferential welds (70A/70B and 72A/72B or 80/84 and 82/86 or 80/88 and 82/90). Each pair of welds comprises first and second welds on opposed surfaces (58, 74) of the shell. The first and second welds compensate each other with respect to welding process shrinkage, eliminating weld warping (68) of the shell. The first and second welds may have equal cross sectional areas or equal masses over a circumferential span of the flange.

### FIELD OF THE INVENTION

The invention relates to manufacturing methods for gas turbine exhaust diffusers, and particularly to welding a seal flange around a diffuser shell at an axially intermediate position on the shell.

### BACKGROUND OF THE INVENTION

A gas turbine (GT) exhaust diffuser is a divergent annular duct lined by inner and outer annular shells through which the exhaust gas passes. The cross-sectional area of the duct progressively increases in the flow direction. This serves to reduce the speed of the exhaust flow and increase its pressure. The exhaust gas may have a temperature of 550-650° C. or more. This causes thermal stresses on components of the exhaust section from operational thermal gradients and cyclic differential expansion fatigue during GT starts and shutdowns. Such stresses are concentrated at interconnections between structures due to differential thermal expansion.

A circular array of struts span between the aft hub of the turbine shaft and the surrounding outer cylinder of the exhaust section. Each strut is surrounded by a tubular heat shield connected between the inner and outer diffuser shells, which fix the two shells together in a diffuser duct assembly. This assembly may be attached to a diffuser support structure that allows the diffuser to float axially and radially within the outer cylinder to accommodate differential thermal expansion.

An annular flange may be needed around the radially inner surface of the inner shell and/or the radially outer surface of the outer shell at an axially intermediate position between the front and back ends of the shell to provide annular gas seal contact surfaces. The flange is formed separately, then it is welded into position on the shell at the desired location.

### BRIEF DESCRIPTION OF THE DRAWINGS

The invention is explained in the following description in view of the drawings that show:

FIG. 1 is an axial sectional view of an exhaust section of a gas turbine taken along line 1-1 of FIG. 2.

FIG. 2 is a transverse sectional view of the exhaust section taken along line 2-2 of FIG. 1.

FIG. 3 is a sectional view of a prior art embodiment of a forward inner seal flange, showing warping (dashed) caused by process shrinkage of the welds.

FIG. 4 is a partial sectional view of a diffuser inner shell assembly with a forward inner seal flange according to an embodiment of the invention.

FIG. 5 is a view as in FIG. 4 after machining excess flange and weld material flush with the gas path surface of the inner diffuser shell.

FIG. 6 is a sectional view of second embodiment of the invention.

FIG. 7 is a sectional view of a third embodiment of the invention.

### DETAILED DESCRIPTION OF THE INVENTION

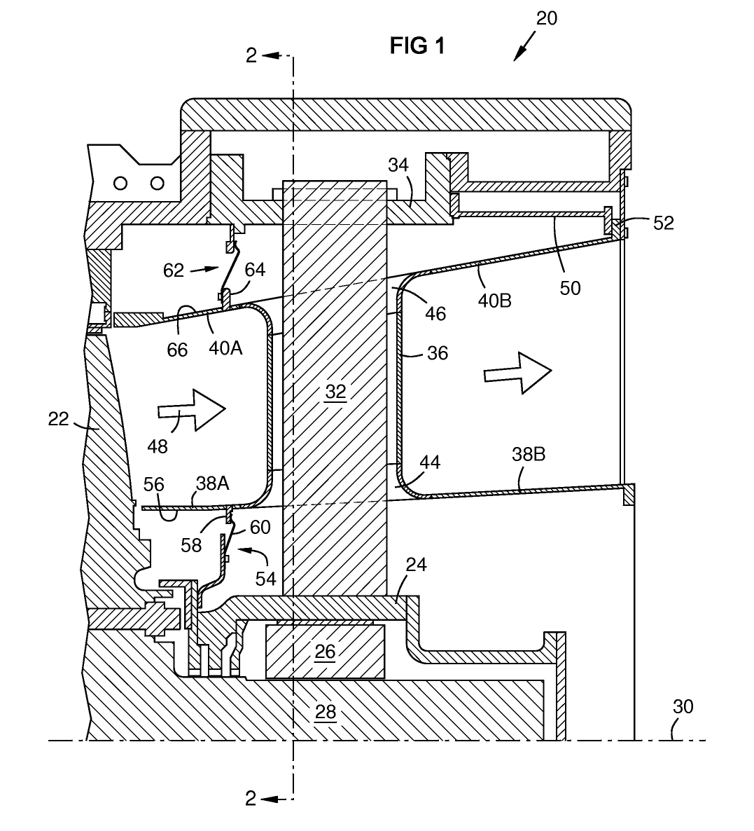

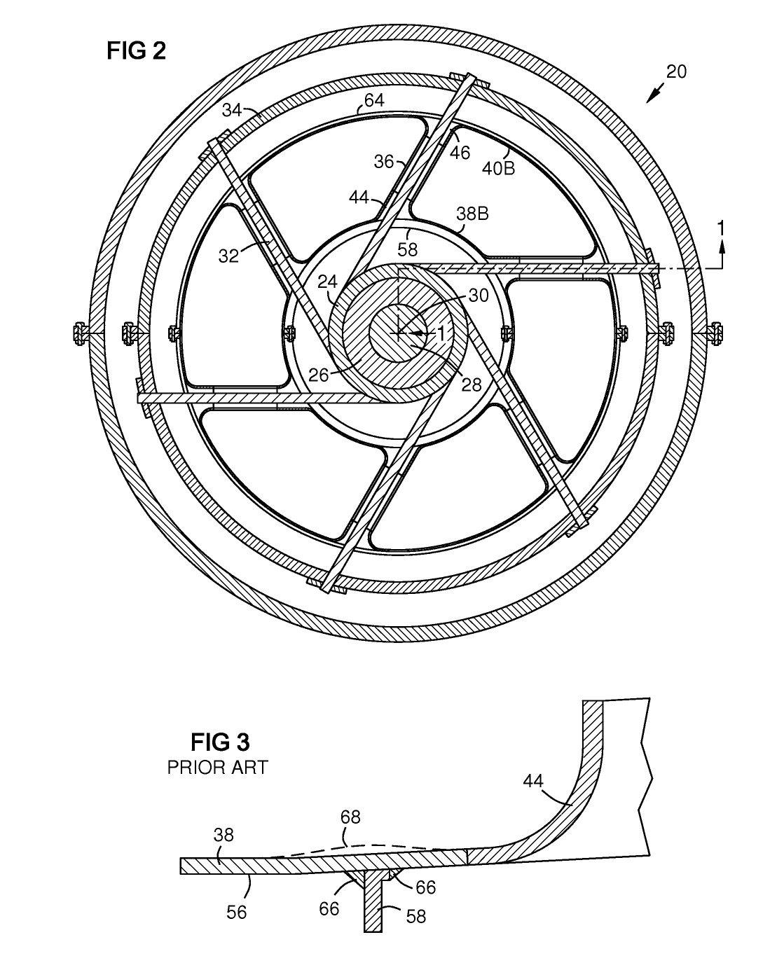

FIG. 1 illustrates an upper half of an exhaust section 20 of a gas turbine engine behind a last row of rotating blades 22. A bearing hub 24 may extend into the exhaust section and enclose an aft bearing 26 that supports the turbine shaft 28 for rotation about an axis 30. A divergent annular flow path for exhaust gas 48 is defined between an inner diffuser shell 38A-B and an outer diffuser shell 40A-B, where “A” and “B” designate respective forward and aft portions of the shells. The turbine axis 30 is also a geometric axis of some annular components of the exhaust section, including the inner and outer diffuser shells. A circular array of struts 32 spans between the hub and an outer cylinder 34. For conceptual clarity, FIG. 1 appears as though the struts are oriented radially. However, they may be oriented tangentially to the hub as shown in FIG. 2.

Each strut may be surrounded by a tubular heat shield 36 connected between the inner and outer diffuser shells. An inner collar 44 and an outer collar 46 may be provided on each shield 36 to attach the shield to the respective diffuser shell. The shields/collars fix the shells to each other, thus forming a diffuser duct assembly 36, 38A-B, 40A-B, 44, 46. An annular diffuser support structure 50 is attached to the outer cylinder 34. The diffuser support structure 50 may take the form of a ring or a circular array of adjacent plates. An aft portion of the outer diffuser shell 40B is attached to this support structure by an outer diffuser aft flange 52. This affixes the diffuser duct assembly to the outer cylinder 34 in such a way that the duct assembly floats axially and radially within the outer cylinder 34 to accommodate differential thermal expansion. A forward inner seal 54 may be provided around a radially inner surface 56 of the inner diffuser shell 38A-B to separate gas areas having different temperatures and/or pressures. This seal may include an annular inner flange 58 welded to the shell 38A-B. It may further include a flexible annular seal member 60 that maintains sealing contact with the flange 58. A similar forward outer seal 62 with an annular outer flange 64 may be provided around a radially outer surface 66 of the outer diffuser shell 40A-B. Each seal 54, 62 may be located at an axially intermediate position between the upstream and downstream ends of the respective diffuser shells 38A-B, 40A-B.

FIG. 2 is a transverse sectional view of the GT exhaust section 20 of FIG. 1. A hub 24 encloses an aft bearing 26 that supports the turbine shaft 28 for rotation about an axis 30. A circular array of struts 32 connects the hub to the outer cylinder 34 for mutual support. The struts may be oriented tangentially to the hub as shown to accommodate differential thermal expansion between the hub, struts, and outer cylinder. Each strut is surrounded by a heat shield 36 connected between the inner 38A-B and outer 40A-B diffuser shells. An inner collar 44 and an outer 46 collar may be used to attach each heat shield to a respective diffuser shell portion 38B, 40B.

FIG. 3 is a sectional view of a prior art embodiment of a forward inner seal flange 58 welded to shell 38. The inventors have realized that welding such an annular flange around a diffuser shell can cause distortion of the shell from asymmetric shrinkage caused by the welding process being applied to only one surface of the shell. FIG. 3 illustrates possible warping 68 of the diffuser shell 38 caused by process shrinkage of the welds 66. This flange is conventionally welded around the inner diffuser shell 38 with fillet welds 66 as shown. These welds warp the diffuser shell due to weld process shrinkage on the inner surface 56 of the shell. Because the diffuser is designed as an aerodynamic structure, such warping 68 has been identified by the inventors as a source of reduce diffuser performance.

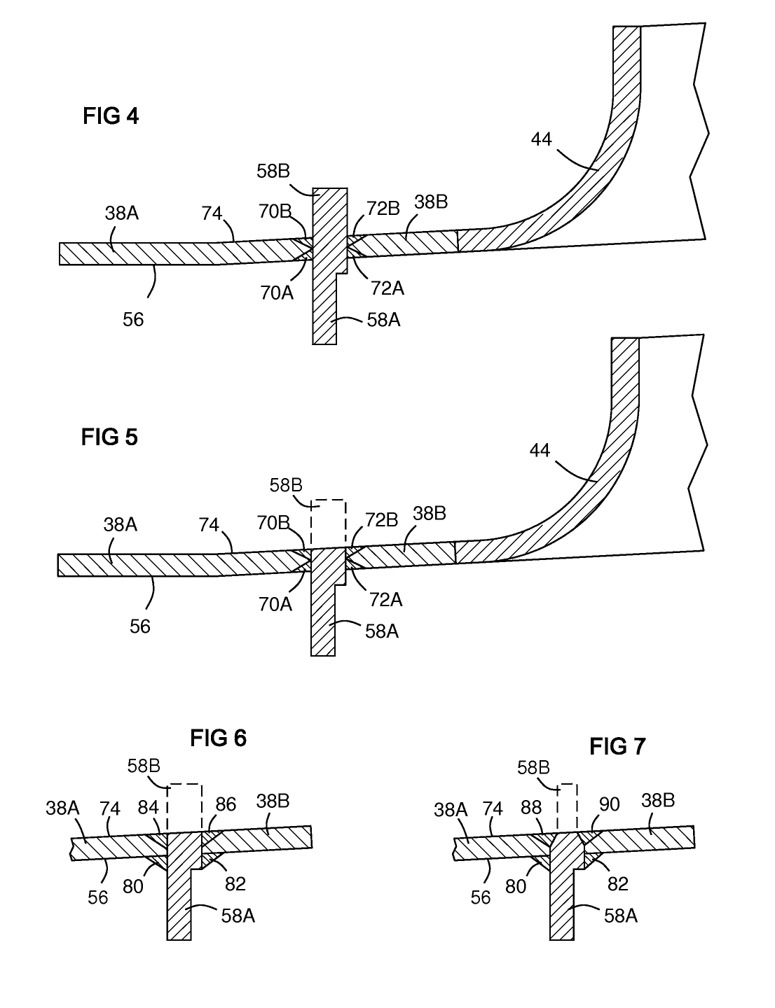

FIG. 4 partially shows an inner diffuser shell assembly in a welding step according to an embodiment of the invention. The inner diffuser shell is assembled from a forward portion 38A and an aft portion 38B, which are welded to opposite sides of the forward inner seal flange 58A using double bevel welds 70A-B and 72A-B. The flange may have a portion 58B that extends beyond the exhaust gas flow surface 74 of the inner shell. This flange extension portion 58B facilitates fixturing and also facilitates weld abutment and symmetric weld cooling across the wall thickness of the diffuser shell 38A-B. The double bevel welds 70A-B and 72A-B do not warp the diffuser shell, because they provide symmetric process shrinkage across thickness of the shell. The inventors have found that such a welding configuration is effective to eliminate or minimize shell distortion during the fabrication process, thereby overcoming the problematic warping 68 of the prior art.

FIG. 5 shows the assembly of FIG. 4 after removing (such as by grinding or machining) the extended portion 58B and removing any excess material of the outer welds 70B, 72B flush with the exhaust flow surface 74 of the inner shell 38A-B.

FIG. 6 shows an embodiment in which each side of the flange 58A has a single-bevel butt weld 84, 86 and a compensating fillet weld 80, 82 on the opposite surface of the shell. “Compensating” means that each pair of opposed welds 80/84, and 82/86 produce essentially the same process shrinkage on opposite surfaces 56, 74 of the diffuser shell 38A-B, such that the opposed welding shrinkages complement each other to eliminate warping. This can be achieved by providing each weld with the same cross-sectional area and shape or at least the same cross-sectional area as the opposed weld in each pair 80/84, 82/86. For example welds 80 and 84 may have equal cross-sectional shapes, or at least equal cross-sectional areas. Since nothing manufactured by man is completely uniform or perfect in dimension, the word “equal”, as used herein, is intended to cover methods and apparatuses with commercial manufacturing tolerances. Thus, “equal cross-sectional areas” means the fusion zones of two welds have equal cross sectional areas within commercial manufacturing tolerances. To the extent that some small amount of warping is experienced, the subsequent material removal step used to eliminate the extension portion 58B may be effective to restore a desired gas flow path surface geometry to surface 74.

FIG. 7 shows an embodiment with double bevel welds 88, 90 compensating fillet welds 80, 82, in which the compensating welds do not have the same cross-sectional shapes, but may have the same cross-sectional areas. Other weld combinations may be used as long as the opposed shrinkages across the two surfaces 56, 74 of the shell 38A-B compensate each other to eliminate warping.

The outer welds 70B, 72B, 84, 86, 88, 90 have a slightly greater circumferential length, and thus more absolute circumferential shrinkage, than the respective inner welds 70A, 72A, 80, 82. This difference can be reduced by making the inner and outer weld equal in mass over a given circumferential angle, such as the circumferential angle or span of the flange, by making the cross sectional area of the outer weld slightly smaller than the cross sectional area of the opposed inner weld. For example, the circumferential span of the flange may be 180 degrees on each upper/lower half of a diffuser shell if the shell is assembled from upper/lower halves, or it may be some other circumferential angle up to 360 degrees, depending on if/how the flange is assembled from arcuate segments.

Each diffuser shell may be fabricated in forward and aft portions 38A/38B, 40A/40B which are joined along the flanges 58A, 64. Each flange may be oriented along a plane transverse to turbine axis 30.

The method herein produces an arcuate diffuser shell (38A/38B) assembled from an axially forward portion (38A) and an axially aft portion (38B), the two portions welded to respective sides of an arcuate flange (58A) via two respective pairs of circumferential welds (70A/70B and 72A/72B or 80/84 and 82/86 or 80/88 and 82/90). Each pair of welds comprises first and second welds on opposite surfaces (58, 74) of the shell, which compensate each other with respect to welding process shrinkage, eliminating weld warping of the shell. The first and second welds may have equal cross sectional fusion areas or equal fusion area masses over a circumferential span of the flange.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method for manufacturing a gas turbine exhaust diffuser comprising:
forming an arcuate diffuser shell comprising at least a forward portion and an aft portion;
forming an arcuate flange;
welding the flange between the forward and aft portions of the diffuser shell with welds that compensate each other with respect to a first welding process shrinkage on a first surface of the shell that bounds a turbine exhaust gas flow path versus a second welding process shrinkage on a radially opposed second surface of the shell.

2. The method of claim 1, further comprising:
forming the flange with an extension that extends into the exhaust gas flow path of the diffuser;
welding the flange to the forward portion of the diffuser shell with a first forward weld on said first surface and a second forward weld on said second surface;
welding the flange to the aft portion of the diffuser shell with a first aft weld on said first surface and a second aft weld on said second surface;
removing the extension and the two first welds flush with said first surface.

3. The method of claim 1, further comprising:
welding the flange to the forward portion of the diffuser shell with a first forward weld on said first surface and a second forward weld on said second surface, the two forward welds having equal masses over a given circumferential span of the flange; and
welding the flange to the aft portion of the diffuser shell with a first aft weld on said first surface and a second aft weld on said second surface, the two aft welds having equal masses over the given circumferential span of the flange.

4. The method of claim 1, further comprising:
welding the flange to the forward portion of the diffuser shell with a first forward weld on said first surface and a second forward weld on said second surface, the two forward welds having equal cross sectional areas; and
welding the flange to the aft portion of the diffuser shell with a first aft weld on said first surface and a second aft weld on said second surface, the two aft welds having equal cross sectional areas.

5. The method of claim 1, further comprising;
welding the flange to the forward portion of the diffuser shell with a first forward weld on said first surface and a second forward weld on said second surface, the two forward welds having equal cross sectional areas and shapes; and
welding the flange to the aft portion of the diffuser shell with a first aft weld on said first surface and a second aft weld on said second surface, the two aft welds having equal cross sectional areas and shapes.

6. The method of claim 1, further comprising welding the flange to the forward portion of the diffuser shell with a first double-bevel butt weld, and welding the flange to the aft portion of the diffuser shell with a second double-bevel butt weld.

7. The method of claim 1, further comprising:
welding the flange to the forward portion of the diffuser shell with a forward single-bevel butt weld on said first surface and a forward fillet weld on said second surface, the two forward welds having equal masses over a given circumferential span of the flange; and
welding the flange to the aft portion of the diffuser shell with an aft single-bevel butt weld on said first surface, and an aft fillet weld on said surface, the two aft welds having equal masses over the given circumferential span of the flange.

8. The method of claim 1 further comprising:
welding the flange to the forward portion of the diffuser shell with a forward single-V weld on said first surface and a forward fillet weld on said second surface, the two forward welds having equal masses over a given circumferential span of the flange; and
welding the flange to the aft portion of the diffuser shell with an aft single-V weld on said first surface and an aft fillet weld on said second surface, the two aft welds having equal masses over the given circumferential span of the flange.

9. A product made by the process of claim 2.

10. A product made by the process of claim 3.

11. A product made by the process of claim 4.

12. A product made by the process of claim 5.

13. A product made by the process of claim 6.

14. A product made by the process of claim 7.

15. A product made by the process of claim 8.

16. A method for manufacturing a gas turbine exhaust diffuser, the method comprising:
forming an arcuate diffuser shell comprising a forward portion, an aft portion, a first surface that bounds an exhaust gas flow path and a second surface opposite the first surface across a wall of the shell;
forming an arcuate flange;
welding the flange to the forward portion of the diffuser shell with first and second radially opposed forward welds on the respective first and second surfaces of the shell;
welding the flange to the aft portion of the diffuser shell with first and second radially opposed aft welds on the respective first and second surfaces of the shell; and
removing excess material from the flange, forward portion, aft portion, first forward weld and first aft weld as necessary to establish the first surface to a desired flush geometry.

17. The method of claim 16, further comprising:
configuring the two forward welds to compensate each other with respect to welding process shrinkage on the first and second surfaces by matching respective cross-sectional areas thereof; and
configuring the two aft welds to compensate each other with respect to welding process shrinkage on the first and second surfaces by matching respective cross-sectional areas thereof.

18. The method of claim 16, further comprising:
configuring the two forward welds by matching respective masses thereof over a given circumferential span of the flange; and
configuring the two aft welds by matching respective masses thereof over the given circumferential span of the flange.

19. A product made by the process of claim 16.

20. An arcuate diffuser shell for a gas turbine exhaust assembled from an axially forward portion and an axially aft portion welded to respective sides of an arcuate flange via two respective pairs of circumferential welds, wherein each said pair of welds comprises first and second welds on opposed surfaces of the shell.
